(19) United States
(12) Patent Application Publication
(10) Pub. No.: US 2021/0083818 A1
(43) Pub. Date: Mar. 18, 2021

(54) WIRELESS COMMUNICATION METHOD, USER EQUIPMENT AND BASE STATION

(71) Applicant: NTT DOCOMO, INC., Tokyo (JP)

(72) Inventors: Qin Mu, Beijing (CN); Liu Liu, Beijing (CN); Wenjia Liu, Beijing (CN); Xiaolin Hou, Beijing, Haidian District (CN)

(73) Assignee: NTT DOCOMO, INC., Tokyo (JP)

(21) Appl. No.: 16/962,486

(22) PCT Filed: Jan. 16, 2018
(86) PCT No.: PCT/CN2018/072891

§ 371 Date: Jul. 15, 2020

(51) Int. Cl. H04L 5/00

(52) U.S. Cl. CPC H04L 5/0048

(57) ABSTRACT

Provided are a wireless communication method applied to a user equipment, a wireless communication method applied to a base station, user equipment and a base station, the wireless communication method applied to the user equipment includes: jointly selecting multiplexing identification information and a reference signal for the user equipment, the multiplexing identification information being used to distinguish data of the user equipment from data of other user equipment; using the selected multiplexing identification information to perform processing on the data; and sending the processed data and the reference signal.

### TECHNICAL FIELD

The present application relates to the field of wireless communication, and more particularly, to a wireless communication method applied to a user equipment, a wireless communication method applied to a base station, a user equipment and a base station.

### BACKGROUND

In a wireless communication system based on the non-orthogonal multiple access (NOMA) technology, data of a plurality of user equipment is multiplexed in the same time-frequency resource for non-orthogonal transmission at the transmitting end; demodulation of data of respective user equipment is implemented by serial interference cancellation (SIC) at the receiving end. In order to implement correct demodulation of data of respective user equipment, the base station allocates a different spreading sequence or a different scrambling code or the like to each user equipment, so that data of different user equipment on the same time-frequency resource is processed with the different spreading sequence or the different scrambling code or the like so as to be distinguished from each other. Herein, since the spreading sequence or scrambling code can be used to distinguish data of different user equipment, it can be generally referred to as the multiplexing identification information. In addition, the base station also assigns to each user equipment a reference signal specific to the user equipment, such as a demodulation reference signal (DM-RS). Each user equipment transmits the allocated reference signal to the base station, so that the base station estimates a channel state between the base station and the user equipment according to the reference signal, and demodulates the received data according to the estimated channel state.

In order to reduce signaling overhead between the user equipment and the base station, a resource allocation method based on RACH-less scheduling is proposed. In this case, instead of allocating the multiplexing identification information and the reference signal by the base station, the user equipment selects the multiplexing identification information from a pre-configured multiplexing identification information set to process the data to be transmitted, and the user equipment selects the reference signal from a pre-configured configured reference signal set and transmits it to the base station. At this time, if two or more user equipment using the same time-frequency resource select the same multiplexing identification information or the same reference signal, a multiplexing identification information conflict or a reference signal conflict is generated between the data transmitted by the user equipment. No matter a conflict occurs to either one of the multiplexing identification information and the reference signal, or a conflict occurs to both the multiplexing identification information and the reference signal, all can result in a demodulation failure of data of the user equipment at the receiving end.

Therefore, there is a need for a wireless communication method that reduces conflict between the multiplexing identification information and/or the reference signal selected by a plurality of user equipment.

### SUMMARY

According to an aspect of the present disclosure, there is provided a wireless communication method, applied to a user equipment, the method comprising: jointly selecting multiplexing identification information and a reference signal for the user equipment, the multiplexing identification information being used to distinguish data of the user equipment from data of other user equipment; processing the data by using the selected multiplexing identification information; transmitting the processed data and the reference signal.

According to another aspect of the present disclosure, there is provided a wireless communication method, applied to a base station, comprising: receiving data and a reference signal transmitted from a user equipment; jointly selecting multiplexing identification information and a reference signal for the user equipment, the multiplexing identification information being used to distinguish data of the user equipment from data of other user equipment; demodulating the data according to the multiplexing identification information and the reference signal that are selected.

According to another aspect of the present disclosure, there is provided a user equipment, comprising: a selecting unit configured to jointly select multiplexing identification information and a reference signal for the user equipment, the multiplexing identification information being used to distinguish data of the user equipment from data of other user equipment; a processing unit configured to process the data by using the selected multiplexing identification information; a transmitting unit configured to transmit the processed data and the reference signal.

According to another aspect of the present disclosure, there is provided a base station, comprising: a receiving unit configured to receive data and a reference signal transmitted from a user equipment; a selecting unit configured to jointly select multiplexing identification information and a reference signal for the user equipment, the multiplexing identification information being used to distinguish data of the user equipment from data of other user equipment; a demodulating unit configured to demodulate the data according to the multiplexing identification information and the reference signal that are selected.

In the above aspects of the present disclosure, jointly selecting the multiplexing identification information and the reference signal for the user equipment may cause the multiplexing identification information conflict and the reference signal conflict to concurrently occur as much as possible, and reduce the probability of separate occurrence of one of the multiplexing identification information conflict and the reference signal conflict, thereby reducing the probability of conflict occurrence between data transmitted by different user equipment, and improving correct demodulation probability for the received data by the base station.

### BRIEF DESCRIPTION OF THE DRAWINGS

Through the detailed description of embodiments of the present disclosure described with reference to the accompanying drawings, the above and other objectives, features, and advantages of the present disclosure will become more apparent.

FIG. 1 shows a schematic diagram of a wireless communication system for implementing an embodiment of the present disclosure;

FIG. 2 shows a flowchart of a wireless communication method performed by a user equipment according to an embodiment of the present disclosure;

FIG. 3 shows an example of selecting the multiplexing identification information and the reference signal by the user equipment in a first implementation in an embodiment of the present disclosure;

FIG. 4 shows an example of the multiplexing identification information and the reference signal selected by the user equipment in a conventional method;

FIG. 5 shows an example of selecting the multiplexing identification information and the reference signal by the user equipment in a second implementation in an embodiment of the present disclosure;

FIG. 6 shows an example of selecting the multiplexing identification information and the reference signal by the user equipment in a third implementation in an embodiment of the present disclosure;

FIG. 7 shows a flowchart of a wireless communication method performed by a base station according to an embodiment of the present disclosure;

FIG. 8 shows a schematic structural diagram of a user equipment according to an embodiment of the present disclosure;

FIG. 9 shows a schematic structural diagram of a base station according to an embodiment of the present disclosure;

FIG. 10 shows a schematic diagram of hardware structure of a user equipment and a base station according to an embodiment of the present disclosure.

### DETAILED DESCRIPTION OF THE EMBODIMENTS

A wireless communication method and corresponding user equipment and base station according to embodiments of the present disclosure will be described below with reference to the accompanying drawings. In the drawings, the same reference numerals are used to refer to the same elements. It is to be understood that the embodiments described herein are illustrative only and should not be construed as limiting the scope of the present disclosure.

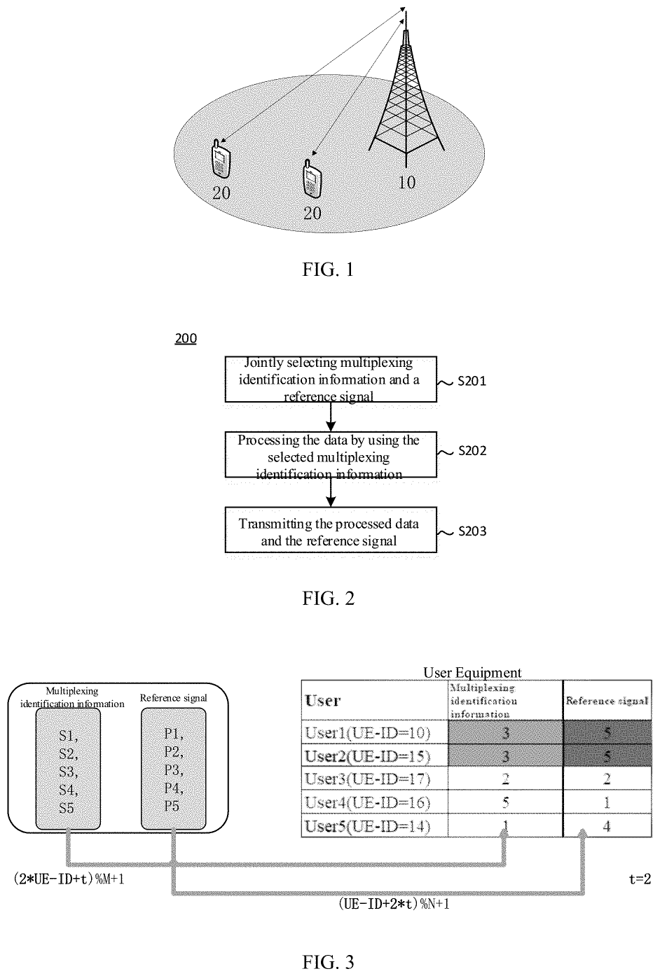

FIG. 1 shows a schematic diagram of a wireless communication system for implementing an embodiment of the present disclosure.

As shown in FIG. 1, the wireless communication system includes a base station (BS) 10 and two user equipment (UE) 20, the two user equipment 20 can transmit their own data to the base station 10. For example, the wireless communication system can be a NOMA-based system, and the two user equipment 20 can transmit their data to the base station 10 via the NOMA. It will be realized that although one base station and two user equipment are shown in FIG. 1, this is merely illustrative and the wireless communication system may also include more base stations and/or more user equipment.

Each user equipment 20 selects multiplexing identification information (signature) and a reference signal, processes data using the selected multiplexing identification information, and transmits the processed data and the selected reference signal to the base station. The base station 10 receives the data and the reference signal transmitted by each user equipment 20, performs channel estimation using the received reference signal, and demodulates the data using the multiplexing identification information according to a channel estimation result.

In an embodiment of the present disclosure, in order to reduce conflict occurrence of multiplexing identification information and/or reference signal selected by the different user equipment, thereby reducing the probability of conflict occurrence between the data transmitted by the different user equipment, the multiplexing identification information and the reference signal are jointly selected for each user equipment.

A wireless communication method according to an embodiment of the present disclosure, which may be performed by the user equipment 20, is described below with reference to FIG. 2. FIG. 2 shows a flowchart of the wireless communication method.

As shown in FIG. 2, in step S201, the user equipment 20 may jointly select multiplexing identification information and a reference signal for the user equipment 20.

Herein, the multiplexing identification information is used to distinguish data of the user equipment 20 from data of other user equipment. For example, the multiplexing identification information may be used in the NOMA to process data of the user equipment 20 in a corresponding mode, so that data of a plurality of user equipment can be multiplexed on the same time-frequency resource. In one example, since data of respective user equipment can be processed by a different spreading sequence to separate data of respective user equipment, thus the spreading sequence can be the multiplexing identification information. In another example, since data of respective user equipment can be randomized by using a scrambling code sequence to separate data of respective user equipment, thus the scrambling code sequence can be the multiplexing identification information. In another example, data of respective user equipment may be rearranged by a different interleaving manner to distinguish data of respective user equipment, thus the interleaving manner may be the multiplexing identification information. It should be noted that the multiplexing identification information is not limited to the above examples, but may be any mode, sequence, indication information, and the like used to distinguish data of the user equipment from data of other user equipment.

Furthermore, the reference signal may, for example, be a demodulation reference signal, which is used to estimate, at the base station, a channel state between the base station and the user equipment.

Joint selection of the multiplexing identification information and the reference signal can be implemented in a variety of ways.

In a first implementation, the user equipment 20 may select the multiplexing identification information and the reference signal from a multiplexing identification information set and a reference signal set respectively based on the same parameter.

The user equipment 20 may select the multiplexing identification information for the user equipment from the multiplexing identification information set. As described above, the multiplexing identification information may be a spreading sequence, an interleaving manner, or a scrambling code etc., correspondingly, the multiplexing identification information set may be a set of spreading sequences including a plurality of spreading sequences, a set of scrambling code sequences including a plurality of scrambling code sequences, or a set of interleaving manners including a plurality of interleaving manners. Further, the user equipment 20 may select the reference signal for the user equipment from the reference signal set. The reference signal set may, for example, be a set comprising a plurality of demodulation reference signals. The multiplexing identification information set and/or the reference signal set may be configured by the base station 10 according to actual conditions, and transmitted to the user equipment 20 by signaling (e.g., high layer signaling). Alternatively, the multiplexing identification information set and/or the reference signal set may be pre-configured in the base station and the user equipment. For example, the multiplexing identification information set and/or the reference signal set may be a multiplexing identification information set and/or a reference signal set as specified in the 3GPP (Third Generation Partnership Project) standard.

Specifically, the multiplexing identification information for the user equipment may be selected from the multiplexing identification information set based on one or more parameters. The one or more parameters may be pre-configured. Alternatively, the one or more parameters may be parameters selected by the user equipment in a parameter set randomly or according to a preset rule. The parameter set may be pre-configured, for example, the parameter set may be pre-configured in the base station and the user equipment, for example, the parameter set may be a parameter set specified under the 3GPP standard. Alternatively, the parameter set may be configured by the base station and notified to the user equipment by signaling (e.g., higher layer signaling). As an example, the parameter set may include ID of the user equipment (UE-ID), a time (t) at which the user equipment transmits data, or one or more pseudo-random sequences, and the like. Furthermore, the reference signal may be selected from the reference signal set based on one or more parameters, i.e., the parameter same as that used to select the multiplexing identification information for the user equipment from the multiplexing identification information set.

FIG. 3 shows an example of selecting the multiplexing identification information and the reference signal by the user equipment in a first implementation in an embodiment of the present disclosure. As shown in FIG. 3, the multiplexing identification information set includes five multiplexing identification information (S1, S2, S3, S4, and S5), and the reference signal set includes five reference signals (P1, P2, P3, P4, and P5). The user equipment 20 may select the multiplexing identification information from the multiplexing identification information set and select the reference signal from the reference signal set respectively based on the same parameter. In this example, it is assumed that the user equipment selects the multiplexing identification information and the reference signal according to two parameters, namely, the ID of the user equipment (UE-ID) and the time (t) at which the user equipment transmits data. For example, the user equipment may use Formula (1) including the two parameters to select an index value corresponding to the multiplexing identification information of the user equipment from the multiplexing identification information set:

I=(2*UE-ID+t) % M+1 (1)

where M is a quantity of multiplexing identification information in the multiplexing identification information set, and % is a remainder operator. In addition, the user equipment can use Formula (2) including the two parameters to select an index value corresponding to the reference signal of the user equipment from the reference signal set:

J=(UE-ID+2*t) % N+1 (2)

where N is a quantity of reference signals in the reference signal set.

According to the above two formulas, as for the transmission time t=2, the user equipment 1 (UE-ID=10) selects the multiplexing identification information S3 and the reference signal P5, the user equipment 2 (UE-ID=15) selects the multiplexing identification information S3 and the reference signal P5, the user equipment 3 (UE-ID=17) selects the multiplexing identification information S2 and the reference signal P2, the user equipment 4 (UE-ID=16) selects the multiplexing identification information S5 and the reference signal P1, the user equipment 5 (UE-ID=14) selects the multiplexing information S1 and the reference signal P4.

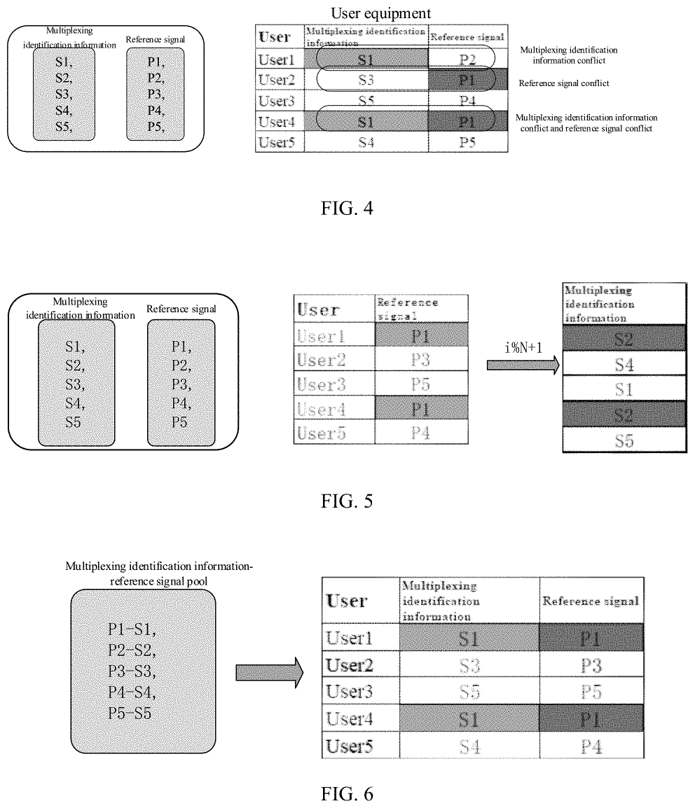

It can be seen from FIG. 3 that the multiplexing identification information and the reference signal selected by the user equipment 1 and the user equipment 2 are respectively the same, that is, the multiplexing identification information conflict and the reference signal conflict occur concurrently on the same time-frequency resource, whereas there is no conflict occurring between the remaining user equipment 3, user equipment 4, user equipment 5 and other user equipment, that is, there is no conflict occurrence of only one of the multiplexing identification information and the reference signal of the two user equipment. In other words, with the embodiment of the present disclosure, it is enabled that when the multiplexing identification information conflict occurs between two user equipment, the reference signal conflict also occurs at the same time, or it is enabled that when the multiplexing identification information between the two user equipment does not conflict, the reference signal does not conflict either. In contrast, in the conventional system, due to separate selection of the multiplexing identification information and the reference signal, three types of conflict situations as shown in FIG. 4 may occur, conflict of only the multiplexing identification information, conflict of only the reference signal, and conflict of both the multiplexing identification information and the reference signal. Therefore, compared with the case shown in FIG. 4, the embodiment of the present disclosure can reduce the probability of conflict occurrence of the data transmitted between different user equipment, and facilitate correct demodulation of the received data by the base station.

It should be realized that although it is shown in the above example that five multiplexing identification information are included in the multiplexing identification information set, five reference signals are included in the reference signal set, the multiplexing identification information set and the reference signal set may include more or less multiplexing identification information, and/or more or fewer reference signals in practice. In addition, the parameters used in selecting the multiplexing identification information from the multiplexing identification information set and selecting the reference signal from the reference signal set in the above implementation are merely illustrative, any other parameters or any other combination of parameters may be selected according to actual needs. Furthermore, the formula for selecting the multiplexing identification information from the multiplexing identification information set by the user equipment 20 and the formula for selecting the reference signal from the reference signal set by the user equipment 20 in the above implementation are merely exemplary, the user equipment may use the same or different two formulas to select the multiplexing identification information and the reference signal, and the user equipment can also select the multiplexing identification information and the reference signal from the aforesaid set in any other suitable manner as long as it uses the same parameter to select the two. In addition, it should be recognized that the order of selecting the multiplexing identification information and selecting the reference signal is variable, that is, the multiplexing identification information may be selected first and then the reference signal is selected, or the reference signal may be selected first and then the multiplexing identification information is selected.

In a second implementation, the user equipment 20 may select one of the multiplexing identification information and the reference signal from the multiplexing identification information set or the reference signal set, then correspondingly selects, according to one of the multiplexing identification information and the reference signal that is selected, based on a predetermined association rule between the multiplexing identification information and the reference signal, the other one of the multiplexing identification information and the reference signal from the multiplexing identification information set or the reference signal set. Specifically, the user equipment 20 may select the multiplexing identification information from the multiplexing identification information set, then select, according to the selected multiplexing identification information, based on a predetermined association rule between the multiplexing identification information and the reference signal, the reference signal from the reference signal set. Alternatively, the user equipment 20 may select a reference signal from the reference signal set, and then select, according to the selected reference signal, based on the predetermined association rule between the multiplexing identification information and the reference signal, the multiplexing identification information from the multiplexing identification information set. The predetermined association rule between the multiplexing identification information and the reference signal may be pre-configured in the base station and the user equipment, for example, it may be an association rule specified in the 3GPP standard, or may be configured by the base station and notified to the user equipment through various signaling (e.g., high layer signaling). The multiplexing identification information set and the reference signal set are the same as those described above with reference to the first implementation, details are not repeated herein.

FIG. 5 shows a schematic diagram of selecting the multiplexing identification information and the reference signal by the user equipment 20 in a second implementation in an embodiment of the present disclosure. As shown in FIG. 5, the multiplexing identification information set includes five multiplexing identification information (S1, S2, S3, S4, and S5), and the reference signal set includes five reference signals (P1, P2, P3, P4, and P5). Herein, selection of the reference signal and selection of the multiplexing identification information are taken as an example, however, as described above, the order is variable, the multiplexing identification information may be selected first and then the reference signal is selected.

The user equipment 20 may first select a reference signal from a reference signal set. Specifically, the user equipment 20 may randomly select a reference signal from a reference signal set, and may also select a reference signal from a reference signal set according to a predetermined rule, the predetermined rule may be pre-configured in the base station and the user equipment, for example, it may be a predetermined rule specified in the 3GPP standard, and may also be configured by the base station and notified to the user equipment through various signaling (e.g., higher layer signaling). Thereafter, the user equipment 20 may select multiplexing identification information from a multiplexing identification information set based on a predetermined association rule between the multiplexing identification information and the reference signal, according to the selected reference signal. In this example, it is assumed that the predetermined association rule between the multiplexing identification information and the reference signal is

I=J % M+1 (3)

where M is a quantity of multiplexing identification information in the multiplexing identification information set, % is a remainder operator, J represents an index value corresponding to the reference signal selected in the reference signal set, and I represents an index value corresponding to the multiplexing identification information selected in the multiplexing identification information set.

According to the above formula, the user equipment 20 first selects a reference signal in the reference signal set, and then obtains an index I corresponding to the multiplexing identification information according to an index value J corresponding to the reference signal selected in the reference signal set and the above Formula (3), thereby selecting the multiplexing identification information having the index value I in the multiplexing identification information set.

In the example shown in FIG. 5, N=5, according to the above manner, the reference signal selected by the user equipment 1 is P1 and the multiplexing identification information selected by the user equipment 1 is S2, the reference signal selected by the user equipment 2 is P3 and the multiplexing identification information selected by the user equipment 2 is S4, the reference signal selected by the user equipment 3 is P5 and the multiplexing identification information selected by the user equipment 3 is S1, the reference signal selected by the user equipment 4 is P1 and the multiplexing identification information selected by the user equipment 4 is S2, the reference signal selected by the user equipment 5 is P4 and the multiplexing identification information selected by the user equipment 5 is S5.

It can be seen from FIG. 5 that the multiplexing identification information and the reference signal selected by the user equipment 1 and the user equipment 4 are the same respectively, that is, the multiplexing identification information conflict and the reference signal conflict occur concurrently on the same time-frequency resource, there is no conflict between the remaining user equipment 2, user equipment 3, user equipment 5 and other user equipment. Thus, it is enabled that the reference signal conflict also occurs while the multiplexing identification information conflict occurs between the two user equipment, or the reference signal does not conflict when the multiplexing identification information does not conflict between the two user equipment. Therefore, the probability of conflict occurrence of the data transmitted between different user equipment is reduced compared to the conventional case shown in FIG. 4, it facilitates the base station correctly demodulating the received data.

As described above, the order in which the multiplexing identification information and the reference signal are selected is variable. For example, the user equipment 20 may also first select multiplexing identification information from the multiplexing identification information set. Similarly, the user equipment 20 may select the multiplexing identification information from the multiplexing identification information set randomly, or may select the multiplexing identification information from the multiplexing identification information set according to a predetermined rule, the predetermined rule may be pre-configured in the base station and the user equipment. For example, it may be a predetermined rule specified in the 3GPP standard, and may also be configured by the base station and notified to the user equipment through various signaling (e.g., high layer signaling). Thereafter, the user equipment 20 may select a reference signal from the reference set based on the predetermined association rule between the multiplexing identification information and the reference signal, according to the selected multiplexing identification information. In this example, it is assumed that the predetermined association rule between the multiplexing identification information and the reference signal is

J=I % N+1 (4)

where N is a quantity of reference signals in the reference signal set, % is a remainder operator, J represents an index value corresponding to the selected reference signal in the reference signal set, and I represents an index value corresponding to the multiplexing identification information selected in the multiplexing identification information set.

According to the above formula, the user equipment 20 first selects the multiplexing identification information in the multiplexing identification information set, and then obtains an index value J corresponding to the reference signal according to an index value I corresponding to the multiplexing identification information selected in the multiplexing identification information set and the above Formula (4), thereby selecting reference information having the index value J in the reference signal set. The specific example is as described above, details are not repeated herein.

In a third implementation, the user equipment 20 may select a pair of multiplexing identification information and reference signal from a plurality of pairs of multiplexing identification information and reference signal. Each pair of multiplexing identification information and reference signal is composed of one reference signal and one multiplexing identification information. The plurality pairs of multiplexing identification information and reference signal may be configured by the base station according to actual conditions, and transmitted to the user equipment 20 by signaling (e.g., high layer signaling). Alternatively, the plurality of pairs of multiplexing identification information and reference signal may be pre-configured in the base station and the user equipment, for example, it may be pairs of multiplexing identification information and reference signal specified in the 3GPP standard. For example, the plurality of pairs of multiplexing identification information and reference signal may be selected from a multiplexing identification information-reference signal pool randomly or according to a predetermined rule. The predetermined rule may be pre-configured in the base station and the user equipment, for example, it may be a predetermined rule specified in the 3GPP standard, or may be configured by the base station and notified to the user equipment through various signaling (e.g., high layer signaling).

The user equipment may randomly select one pair of multiplexing identification information and reference signal from a plurality of pairs of multiplexing identification information and reference signal, may also make a selection according to a rule pre-configured in the base station and the user equipment, or according to a rule configured by the base station and notified to the user equipment through various signaling (e.g., higher layer signaling), and may of course make a selection according to a rule specified in the 3GPP standard.

FIG. 6 shows a schematic diagram of selecting the multiplexing identification information and the reference signal by the user equipment 20 in a third implementation in an embodiment of the present disclosure, as shown in FIG. 6, the multiplexing identification information-reference signal pool includes five pairs of multiplexing identification information and reference signal (P1-S1, P2-S2, P3-S3, P4-S4, and P5-S5), the user equipment selects one pair of multiplexing identification information and reference signal from said pairs of multiplexing identification information and reference signal, and uses the multiplexing identification information and the reference signal in this pair as the jointly selected multiplexing identification information and reference signal. For example, based on a result of random selection, the user equipment 1 selects the pair P1-S1 of multiplexing identification information and reference signal, the user equipment 2 selects the pair P3-S3 of multiplexing identification information and reference signal, and the user equipment 3 selects the pair P5-S5 of multiplexing identification information and reference signal, and so on, and so forth.

It can be seen from FIG. 6 that the pair of multiplexing identification information and reference signal selected by the user equipment 1 and the pair of multiplexing identification information and reference signal selected by the user equipment 4 are the same, so the user equipment 1 and the user equipment 4 select the same multiplexing identification information and reference signal, that is, the multiplexing identification information conflict and the reference signal conflict occur concurrently on the same time-frequency resource, whereas there is no conflict occurring between the remaining user equipment 3, user equipment 4, user equipment 5 and other user equipment. Thus, it is enabled that the reference signal conflict also occurs while the multiplexing identification information conflict occurs between the two user equipment, or the reference signal does not conflict when the multiplexing identification information does not conflict between the two user equipment. Therefore, the probability of conflict occurrence of the data transmitted between different user equipment is reduced compared to the conventional case shown in FIG. 4, it facilitates the base station correctly demodulating the received data.

In step S202, the user equipment 20 processes data by using the selected multiplexing identification information.

As described above, the multiplexing identification information may be, for example, a spreading sequence, a scrambling sequence, an interleaving manner, or may be any mode that distinguishes data of the user equipment from data of other user equipment. Accordingly, the user equipment 20 processes data, such as performs spreading, interleaving, scrambling, and the like, by using the selected multiplexing identification information according to the type of the multiplexing identification information. For example, in the NOMA, the user equipment may process data of respective user equipment by using a different spreading sequence, or scramble data of respective user equipment by using a scrambling code sequence, or interleave data of respective user equipment by using a different interleaving manner.

In step S203, the user equipment 20 transmits the processed data and the reference signal.

Optionally, the user equipment 20 may also notify the base station of the multiplexing identification information and the reference signal that are selected. The multiplex identification information and the reference signal that are selected may be notified to the base station through a control channel. For example, in the foregoing first implementation and the second implementation, indication information indicating the multiplexing identification information selected by the user equipment and indication information indicating the selected reference signal may be included in the control channel, the control channel and the processed data are transmitted to the base station 10 together. For example, one or more bits may be set in the control channel to indicate the multiplexing identification information selected by the user equipment 20 (e.g., its index value in the multiplexing identification information set), and one or more bits may be set to indicate the reference signal selected by the user equipment 20 (e.g., its index value in the reference signal set). In the third implementation, indication information indicating a pair of multiplexing identification information and reference signal selected by the user equipment may be included in the control channel, and the control channel and the processed data are transmitted to the base station 10 together. For example, one or more bits may be set in the control channel to indicate the pair of multiplexing identification information and reference signal selected by the user equipment 20 (e.g., its index value in the plurality pairs of multiplexing identification information and reference signal).

In the foregoing embodiment of the present disclosure, jointly selecting the multiplexing identification information and the reference signal for the user equipment may cause the multiplexing identification information conflict and the reference signal conflict to concurrently occur as much as possible, and reduce the probability of separate occurrence of one of the multiplexing identification information conflict and the reference signal conflict, thereby reducing the probability of conflict occurrence between data transmitted by different user equipment, and improving correct demodulation probability for the received data by the base station.

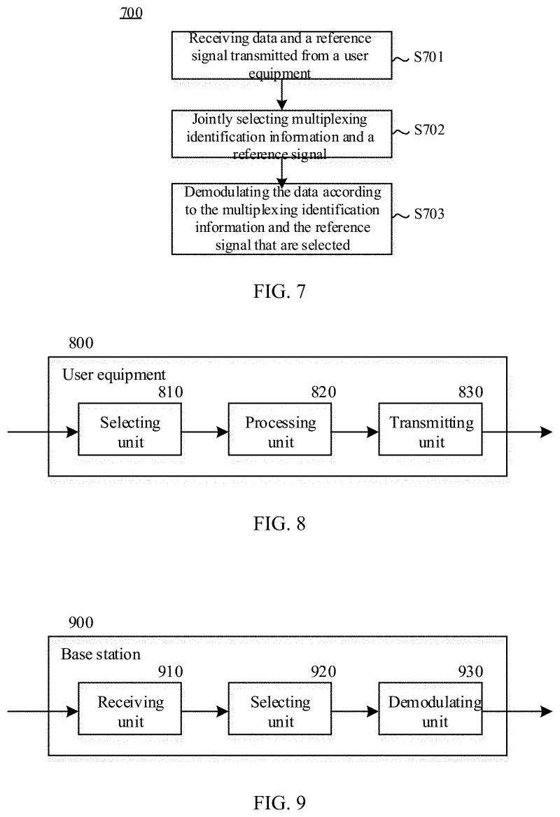

Hereinafter, a wireless communication method performed by a base station according to an embodiment of the present disclosure will be described with reference to FIG. 7. This method corresponds to the method described with reference to FIG. 3, and many details have been described above in accordance with FIG. 3, thus description of the same details is omitted here to avoid repetition.

As shown in FIG. 7, in step S701, data and a reference signal transmitted by the user equipment are received. The reference signal may, for example, be a demodulation reference signal. The data and the reference signal may be received in a manner well known in the art, details are not repeated herein.

Next, in step S702, the base station 10 can jointly select multiplexing identification information and a reference signal for the user equipment. As described above, the multiplexing identification information is used to distinguish data of the user equipment 20 from data of other user equipment. As described above, the multiplexing identification information may be, for example, a spreading sequence, a scrambling sequence, an interleaving manner, or may be any mode that distinguishes data of the user equipment from data of other user equipment, so that data of a plurality of user equipment can be multiplexed on the same time-frequency resource.

Joint selection of the multiplexing identification information and the reference signal can be implemented in a variety of ways.

In a first implementation, as described above, the user equipment 20 may select the multiplexing identification information from the multiplexing identification information set and select the reference signal from the reference signal set respectively based on the same parameter. Accordingly, the base station 10 also selects the multiplexing identification information from the multiplexing identification information set and the reference signal from the reference signal set respectively based on the same parameter. Since the multiplexing identification information set and the reference signal set used by the base station are the same as those at the user side, details are not repeated herein.

Specifically, the base station 10 may first select the multiplexing identification information from the multiplexing identification information set, and the base station 10 may randomly select the multiplexing identification information from the multiplexing identification information set, or may select the multiplexing identification information from the multiplexing identification information set according to a predetermined rule. Next, the base station 10 obtains a parameter value used to select the multiplexing identification information from the multiplexing identification information set according to the same formula (e.g., the above Formula 1) used by the user equipment to select the multiplexing identification information from the multiplexing identification information set, and determines the reference signal according to the parameter value and the same formula for the user equipment to select the reference signal from the reference signal set (e.g., the above Formula 2), because the parameters and formulas used by the user equipment to select the multiplexing identification information from the multiplexing identification information set and the parameters and formulas used by the user equipment to select the reference signal from the reference signal set have been pre-configured in the user equipment and the base station, so they are known to the base station.

As an example, it is assumed that the multiplexing identification information set includes five multiplexing identification information (S1, S2, S3, S4, and S5), and the reference signal set includes five reference signals (P1, P2, P3, P4, and P5). In this example, since the user equipment at the user side uses Formula (1) as well as two parameters, the ID of the user equipment and the time (t) at which the user equipment transmits data, to select the multiplexing identification information from the multiplexing identification information set and uses Formula (2) as well as two parameters, the ID of the user equipment and the time (t) at which the user equipment transmits data, to select the reference signal from the reference signal set, thus the formulas and the two parameters, the ID of the user equipment and the time (t) at which the user equipment transmits data similar to those used at the user side are also used to select the multiplexing identification information and the reference signal at the base station side. Specifically, since the base station has selected the multiplexing identification information from the multiplexing identification information set, and the time (t) at which the user equipment sends the data can be determined, thus the base station can calculate the user ID according to the index of the selected multiplexing identification information in the identification information set and the time (t) by using Formula (1) as described above. Then, the base station 10 selects the reference signal from the reference signal set using Equation (2) based on the determined user ID and the time (t) at which the user equipment transmits data.

In the above, the base station first selects the multiplexing identification information from the multiplexing identification information set, and then selects the reference signal from the reference signal set. However, it should be recognized that the order of selecting the multiplexing identification information and the selection reference signal is variable, that is, the base station 10 may first select the reference signal from the reference signal set, and then determine the value of the parameter by which the reference signal is selected from the reference signal set by the user equipment in the same manner as above, and then select the multiplexing identification information from the multiplexing identification information set according to the same parameter.

In a second implementation, as described above, the user equipment 20 may select one of the multiplexing identification information and the reference signal from the multiplexing identification information set or the reference signal set, and then selects, according to one of the multiplexing identification information and the reference signal that is selected, based on a predetermined association rule between the multiplexing identification information and the reference signal, the other one of the multiplexing identification information and the reference signal from the multiplexing identification information set or the reference signal set. Correspondingly, the base station 10 may also select one of the multiplexing identification information and the reference signal from the multiplexing identification information set or the reference signal set, and then selects, according to one of the multiplexing identification information and the reference signal that is selected, based on a predetermined association rule between the multiplexing identification information and the reference signal, the other one of the multiplexing identification information and the reference signal from the multiplexing identification information set or the reference signal set. Specifically, the base station 10 may select multiplexing identification information from the multiplexing identification information set, then selects, according to the selected multiplexing identification information, based on a predetermined association rule between the multiplexing identification information and the reference signal, the reference signal from the reference signal set. Alternatively, the base station 10 may select a reference signal from the reference signal set, and then select, according to the selected reference signal, based on the predetermined association rule between the multiplexing identification information and the reference signal, the multiplexing identification information from the multiplexing identification information set. Since the predetermined association rule between the multiplexing identification information and the reference signal has been previously configured in the user equipment and the base station, it is known to the base station.

As an example, it is assumed that the base station 10 first selects one multiplex identification information from the multiplexing identification information set. As described above, the base station 10 may randomly select the multiplexing identification information from the multiplexing identification information set, or may select the multiplexing identification information from the multiplexing identification information set according to a predetermined rule. It is assumed that the multiplexing identification information set includes five multiplexing identification information (S1, S2, S3, S4, and S5), and the reference signal set includes five reference signals (P1, P2, P3, P4, and P5). In this example, since the user equipment determines the reference signal according to the selected multiplexing identification information based on the formula (4), the reference signal is also selected at the base station side using the formula that same as that used at the user side. Specifically, since the base station 10 has selected the multiplexing identification information from the multiplexing identification information set, the index value corresponding to the multiplexing identification information can be obtained, and the index value corresponding to the reference signal can be obtained according to the formula (4), and then a reference signal is selected from the reference signal set according to the index value corresponding to the reference signal.

It should also be recognized that the order of selecting the multiplexing identification information and the selection reference signal is variable, that is, the base station 10 may first select the reference signal from the reference signal set, and then determine the value of the parameter by which the reference signal is selected from the reference signal set by the user equipment in the same manner as above, and then select the multiplexing identification information from the multiplexing identification information set according to the same parameter.

In a third implementation, as described above, the user equipment 20 may select one pair of multiplexing identification information and reference signal from a plurality of pairs of multiplexing identification information and reference signal. Accordingly, the base station 10 may also select one pair of multiplexing identification information and reference signal from a plurality of pairs of multiplexing identification information and reference signal. Since the pairs of multiplexing identification information and reference signal included in the multiplexing identification information-reference signal pool are the same as those at the user side, details are not repeated herein.

As an example, it is assumed that the multiplexing identification information-reference signal pool includes five pairs of multiplexing identification information and reference signal (P1-S1, P2-S2, P3-S3, P4-S4, and P5-S5), then the base station 10 selects one pair of multiplexing identification information and reference signal from the pairs of multiplexing identification information and reference signal, and uses the multiplexing identification information and the reference signal in this pair as the jointly selected multiplexing identification information and reference signal.

In step S703, the data is demodulated according to the multiplexing identification information and the reference signal that are selected.

Specifically, the base station 10 may estimate a channel state between the base station and the user equipment according to the reference signal, and then demodulate the received data according to the estimated channel state and the multiplexing identification information. If the demodulation is successful, this means that the multiplexing identification information selected by the base station is the multiplexing identification information selected by the user equipment and used to process the data, and the reference signal selected by the base station is the reference signal selected and transmitted by the user equipment and received by the base station. If the demodulation is unsuccessful, this means that the multiplexing identification information and/or reference signal selected by the base station does not coincide with the multiplexing identification information and/or reference signal selected at the user equipment. In this case, the base station may repeat steps S702 to S703 until the data transmitted by the user equipment is successfully demodulated using the multiplexing identification information and the reference signal that are selected.

The process in which the base station demodulates the received data by traversing the multiplexing identification information in the multiplexing identification information set and/or the reference signal in the reference signal set is described above. This may be performed in a case where the user equipment does not notify the base station of the multiplex identification information and the reference signal that are selected. Alternatively, in the case that the user equipment notifies the multiplexing identification information and the reference signal that are selected to the base station as described above, the above process may not be used, instead the data may be demodulated according to notification from the user equipment. Specifically, in a case where the user equipment notifies the multiplexing identification information and the reference signal that are selected to the base station through the control channel, the base station 10 may first demodulate the control channel to obtain indication information that indicates the multiplexing identification information and the reference signal that are selected by the user equipment as included in the control channel, and module the received data in the manner described above according to the multiplexing identification information and the reference signal indicated by the indication information. For example, in the case where one or more bits in the control channel indicate an index value of the multiplexing identification information and an index value of the reference signal, or an index value of a pair of multiplexing identification information and reference signal, the index value can be determined by demodulating the control channel, so as to determine the multiplexing identification information and the reference signal selected by the user equipment. In this case, since the multiplexing identification information and the reference signal used for demodulation by the base station are the multiplexing identification information and the reference signal used by the user equipment, the data can be successfully demodulated.

Hereinafter, a user equipment according to an embodiment of the present disclosure will be described with reference to FIG. 8. FIG. 8 shows a schematic structural diagram of a user equipment. Since the functions of the user equipment of the present embodiment are the same as those of the method described above with reference to FIG. 2, detailed description of the same contents is omitted herein for the sake of simplicity.

As shown in FIG. 8, the user equipment includes a selecting unit 810, a processing unit 820, and a transmitting unit 830. It should be noted that although only three units of the user equipment 20 are shown in FIG. 8, this is merely illustrative, and the user equipment 20 may also include one or more other units, these units are omitted because of being not related to the inventive concept.

The selecting unit 810 can jointly select the multiplexing identification information and the reference signal for the user equipment 20.

Herein, the multiplexing identification information is used to distinguish data of the user equipment 20 from data of other user equipment. For example, the multiplexing identification information may be used in the NOMA to process data of the user equipment 20 in a corresponding mode, so that data of a plurality of user equipment can be multiplexed on the same time-frequency resource. In one example, since data of respective user equipment can be processed by a different spreading sequence to separate data of respective user equipment, thus the spreading sequence can be the multiplexing identification information. In another example, since data of respective user equipment can be randomized by using a scrambling code sequence to separate data of respective user equipment, thus the scrambling code sequence can be the multiplexing identification information. In another example, data of respective user equipment may be rearranged by a different interleaving manner to distinguish data of respective user equipment, thus the interleaving manner may be the multiplexing identification information. It should be noted that the multiplexing identification information is not limited to the above examples, but may be any mode, sequence, indication information, and the like used to distinguish data of the user equipment from data of other user equipment. In addition, the reference signal may, for example, be a demodulation reference signal, which is used to estimate, at the base station, a channel state between the base station and the user equipment.

The selecting unit 810 can implement joint selection of the multiplexing identification information and the reference signal in a variety of ways.

As described above, in the first implementation, the selecting unit 810 may select the multiplexing identification information and the reference signal from the multiplexing identification information set and the reference signal set respectively based on the same parameter.

The selecting unit 810 may select the multiplexing identification information for the user equipment from the multiplexing identification information set. As described above, the multiplexing identification information may be a spreading sequence, an interleaving manner, or a scrambling code etc., correspondingly, the multiplexing identification information set may be a set of spreading sequences including a plurality of spreading sequences, a set of scrambling code sequences including a plurality of scrambling code sequences, or a set of interleaving manners including a plurality of interleaving manners. Further, the selecting unit 810 may select the reference signal for the user equipment from the reference signal set. The reference signal set may, for example, be a set comprising a plurality of demodulation reference signals. The multiplexing identification information set and/or the reference signal set may be configured by the base station 10 according to actual conditions, and transmitted to the user equipment 20 by signaling (e.g., high layer signaling). Alternatively, the multiplexing identification information set and/or the reference signal set may be pre-configured in the base station and the user equipment. For example, the multiplexing identification information set and/or the reference signal set may be a multiplexing identification information set and/or a reference signal set as specified in the 3GPP (Third Generation Partnership Project) standard.

Specifically, the multiplexing identification information for the user equipment may be selected from the multiplexing identification information set based on one or more parameters. The one or more parameters may be pre-configured. Alternatively, the one or more parameters may be parameters selected by the user equipment in a parameter set randomly or according to a preset rule. The parameter set may be pre-configured. Alternatively, the parameter set may be configured by the base station and notified to the user equipment by signaling (e.g., higher layer signaling). Furthermore, the reference signal may be selected from the reference signal set based on one or more parameters, i.e., the parameter same as that used to select the multiplexing identification information for the user equipment from the multiplexing identification information set.

In a second implementation, the selecting unit 810 may select one of the multiplexing identification information and the reference signal from the multiplexing identification information set or the reference signal set, then correspondingly selects, according to one of the multiplexing identification information and the reference signal that is selected, based on a predetermined association rule between the multiplexing identification information and the reference signal, the other one of the multiplexing identification information and the reference signal from the multiplexing identification information set or the reference signal set. Specifically, the selecting unit 810 may select the multiplexing identification information from the multiplexing identification information set, then select, according to the selected multiplexing identification information, based on a predetermined association rule between the multiplexing identification information and the reference signal, the reference signal from the reference signal set. Alternatively, the selecting unit 810 may select a reference signal from the reference signal set, and then select, according to the selected reference signal, based on the predetermined association rule between the multiplexing identification information and the reference signal, the multiplexing identification information from the multiplexing identification information set. The predetermined association rule between the multiplexing identification information and the reference signal may be pre-configured in the base station and the user equipment, for example, it may be an association rule specified in the 3GPP standard, or may be configured by the base station and notified to the user equipment through various signaling (e.g., high-level signaling). The multiplexing identification information set and the reference signal set are the same as those described above with reference to the first implementation, details are not repeated herein.

In a third implementation, the selecting unit 810 may select a pair of multiplexing identification information and reference signal from a plurality of pairs of multiplexing identification information and reference signal. Each pair of multiplexing identification information and reference signal is composed of one reference signal and one multiplexing identification information. The plurality pairs of multiplexing identification information and reference signal may be configured by the base station according to actual conditions, and transmitted to the user equipment 20 by signaling (e.g., high layer signaling). Alternatively, the plurality of pairs of multiplexing identification information and reference signal may be pre-configured in the base station and the user equipment, for example, it may be pairs of multiplexing identification information and reference signal specified in the 3GPP standard. For example, the plurality of pairs of multiplexing identification information and reference signal may be selected from a multiplexing identification information-reference signal pool randomly or according to a predetermined rule. The predetermined rule may be pre-configured in the base station and the user equipment, for example, it may be a predetermined rule specified in the 3GPP standard, or may be configured by the base station and notified to the user equipment through various signaling (e.g., high layer signaling).

The selecting unit 810 may randomly select one pair of multiplexing identification information and reference signal from a plurality of pairs of multiplexing identification information and reference signal, may also make a selection according to a rule pre-configured in the base station and the user equipment, or according to a rule configured by the base station and notified to the user equipment through various signaling (e.g., higher layer signaling), and may of course make a selection according to a rule specified in the 3GPP standard.

The processing unit 820 processes data by using the selected multiplexing identification information. As described above, the multiplexing identification information may be, for example, a spreading sequence, a scrambling sequence, an interleaving manner, or may be any mode that distinguishes data of the user equipment from data of other user equipment. Accordingly, the processing unit 820 processes data, such as performs spreading, interleaving, scrambling, and the like, by using the selected multiplexing identification information according to the type of the multiplexing identification information. For example, in the NOMA, the user equipment may process data of respective user equipment by using a different spreading sequence, or scramble data of respective user equipment by using a scrambling code sequence, or interleave data of respective user equipment by using a different interleaving manner.

The transmitting unit 830 transmits the processed data and the reference signal.

Optionally, the transmitting unit 830 may also notify the base station of the multiplexing identification information and the reference signal that are selected. The multiplex identification information and the reference signal that are selected may be notified to the base station through a control channel. For example, in the foregoing first implementation and the second implementation, indication information indicating the multiplexing identification information selected by the user equipment and indication information indicating the selected reference signal may be included in the control channel, the control channel and the processed data are transmitted to the base station 10 together. For example, one or more bits may be set in the control channel to indicate the multiplexing identification information selected by the selecting unit 810 (e.g., its index value in the multiplexing identification information set), and one or more bits may be set to indicate the reference signal selected by the selecting unit 810 (e.g., its index value in the reference signal set). In the third implementation, indication information indicating a pair of multiplexing identification information and reference signal selected by the user equipment may be included in the control channel, and the control channel and the processed data are transmitted to the selecting unit 810 together. For example, one or more bits may be set in the control channel to indicate the pair of multiplexing identification information and reference signal selected by the selecting unit 810 (e.g., its index value in the plurality pairs of multiplexing identification information and reference signal).

In the above implementation of the present disclosure, jointly selecting the multiplexing identification information and the reference signal for the user equipment may cause the multiplexing identification information conflict and the reference signal conflict to concurrently occur as much as possible, and reduce the probability of separate occurrence of one of the multiplexing identification information conflict and the reference signal conflict, thereby reducing the probability of conflict occurrence between data transmitted by different user equipment, and improving correct demodulation probability for the received data by the base station.

Next, a base station according to an embodiment of the present disclosure will be described with reference to FIG. 9. FIG. 9 shows a schematic structural diagram of a base station according to an embodiment of the present disclosure. Since the functions of the base station of the present embodiment are the same as those of the method described above with reference to FIG. 7, detailed description of the same content is omitted herein for the sake of simplicity.

As shown in FIG. 9, the base station includes a receiving unit 910, a selecting unit 920, and a demodulating unit 930. It should be noted that although the base station is shown as including only three units in FIG. 9, this is only illustrative, and the base station may also include one or more other units, which are omitted herein because of being not related to the inventive concept.

The receiving unit 910 receives data and a reference signal transmitted by the user equipment. The reference signal may, for example, be a demodulation reference signal. The data and the reference signal may be received in a manner well known in the art, details are not repeated herein.

The selecting unit 920 can jointly select the multiplexing identification information and the reference signal for the user equipment. As described above, the multiplexing identification information is used to distinguish data of the user equipment 20 from data of other user equipment. As described above, the multiplexing identification information may be, for example, a spreading sequence, a scrambling sequence, an interleaving manner, or may be any mode that distinguishes data of the user equipment from data of other user equipment, so that data of a plurality of user equipment can be multiplexed on the same time-frequency resource.

Joint selection of the multiplexing identification information and the reference signal can be implemented in a variety of ways.

In a first implementation, as described above, the selecting unit 810 at the user side may select the multiplexing identification information from the multiplexing identification information set and select the reference signal from the reference signal set respectively based on the same parameter. Accordingly, the selecting unit 920 at the base station side also selects the multiplexing identification information from the multiplexing identification information set and the reference signal from the reference signal set respectively based on the same parameter. Since the multiplexing identification information set and the reference signal set used by the base station are the same as those at the user side, details are not repeated herein.

Specifically, the selecting unit 920 may first select the multiplexing identification information from the multiplexing identification information set, and the selecting unit 920 may randomly select the multiplexing identification information from the multiplexing identification information set, or may select the multiplexing identification information from the multiplexing identification information set according to a predetermined rule. Next, the selecting unit 920 obtains a parameter value used to select the multiplexing identification information from the multiplexing identification information set according to the same formula (e.g., the above Formula 1) used by the user equipment to select the multiplexing identification information from the multiplexing identification information set, and determines the reference signal according to the parameter value and the same formula for the user equipment to select the reference signal from the reference signal set (e.g., the above Formula 2), because the parameters and formulas used by the user equipment to select the multiplexing identification information from the multiplexing identification information set and the parameters and formulas used by the user equipment to select the reference signal from the reference signal set have been pre-configured in the user equipment and the base station, so they are known to the base station.

In the above, the base station first selects the multiplexing identification information from the multiplexing identification information set, and then selects the reference signal from the reference signal set. However, it should be recognized that the order of selecting the multiplexing identification information and the selection reference signal is variable, that is, the selecting unit 920 may first select the reference signal from the reference signal set, and then determine the value of the parameter by which the reference signal is selected from the reference signal set by the user equipment in the same manner as above, and then select the multiplexing identification information from the multiplexing identification information set according to the same parameter

In a second implementation, as described above, the selecting unit 810 at the user side may select one of the multiplexing identification information and the reference signal from the multiplexing identification information set or the reference signal set, and then selects, according to one of the multiplexing identification information and the reference signal that is selected, based on a predetermined association rule between the multiplexing identification information and the reference signal, the other one of the multiplexing identification information and the reference signal from the multiplexing identification information set or the reference signal set. Correspondingly, the selecting unit 920 at the base station side may also may also select one of the multiplexing identification information and the reference signal from the multiplexing identification information set or the reference signal set, and then selects, according to one of the multiplexing identification information and the reference signal that is selected, based on a predetermined association rule between the multiplexing identification information and the reference signal, the other one of the multiplexing identification information and the reference signal from the multiplexing identification information set or the reference signal set. Specifically, the selecting unit 920 may select multiplexing identification information from the multiplexing identification information set, then selects, according to the selected multiplexing identification information, based on a predetermined association rule between the multiplexing identification information and the reference signal, the reference signal from the reference signal set. Alternatively, the selecting unit 920 may select a reference signal from the reference signal set, and then select, according to the selected reference signal, based on the predetermined association rule between the multiplexing identification information and the reference signal, the multiplexing identification information from the multiplexing identification information set. Since the predetermined association rule between the multiplexing identification information and the reference signal has been previously configured in the user equipment and the base station, it is known to the base station.

It should also be recognized that the order of selecting the multiplexing identification information and the selection reference signal is variable, that is, the selecting unit 920 may first select the reference signal from the reference signal set, and then determine the value of the parameter by which the reference signal is selected from the reference signal set by the user equipment in the same manner as above, and then select the multiplexing identification information from the multiplexing identification information set according to the same parameter.

In a third implementation, as described above, the selecting unit 810 at the user side may select one pair of multiplexing identification information and reference signal from a plurality of pairs of multiplexing identification information and reference signal. Correspondingly, the selecting unit 920 at the base station side may also select one pair of multiplexing identification information and reference signal from a plurality of pairs of multiplexing identification information and reference signal. Since the pairs of multiplexing identification information and reference signal included in the multiplexing identification information-reference signal pool are the same as those at the user side, details are not repeated herein.

The demodulating unit 930 demodulates the data according to the multiplexing identification information and the reference signal that are selected. Specifically, the demodulating unit 930 may estimate a channel state between the base station and the user equipment according to the reference signal, and then demodulate the received data according to the estimated channel state and the multiplexing identification information. If the demodulation is successful, this means that the multiplexing identification information selected by the selecting unit 920 is the multiplexing identification information selected by the user equipment and used to process the data, and the reference signal selected by the selecting unit 920 is the reference signal selected and transmitted by the user equipment and received by the receiving unit 910. If the demodulation is unsuccessful, this means that the multiplexing identification information and/or reference signal selected by the selecting unit 920 does not coincide with the multiplexing identification information and/or reference signal selected at the user equipment. In this case, the base station may repeat steps S920 to S930 until the data transmitted by the user equipment is successfully demodulated using the multiplexing identification information and the reference signal that are selected.

The process in which the demodulating unit 930 demodulates the received data by traversing the multiplexing identification information in the multiplexing identification information set and/or the reference signal in the reference signal set is described above. This may be performed in a case where the user equipment does not notify the base station of the multiplex identification information and the reference signal that are selected. Alternatively, in the case that the user equipment notifies the multiplexing identification information and the reference signal that are selected to the base station as described above, the above process may not be used, instead the data may be demodulated according to notification from the user equipment. Specifically, in a case where the user equipment notifies the multiplexing identification information and the reference signal that are selected to the base station through the control channel, the demodulating unit 930 may first demodulate the control channel to obtain indication information that indicates the multiplexing identification information and the reference signal that are selected by the user equipment as included in the control channel, and modules the received data in the manner described above according to the multiplexing identification information and the reference signal indicated by the indication information. For example, in the case where one or more bits in the control channel indicate an index value of the multiplexing identification information and an index value of the reference signal, or an index value of a pair of multiplexing identification information and reference signal, the index value can be determined by demodulating the control channel, so as to determine the multiplexing identification information and the reference signal selected by the user equipment. In this case, since the multiplexing identification information and the reference signal used for demodulation by the demodulating unit 930 are the multiplexing identification information and the reference signal used by the user equipment, the data can be successfully demodulated. Also, since the step of jointly selecting the multiplexing identification information and the reference signal by the selecting unit 920 is reduced, the selecting unit 920 can be omitted.

<Hardware>

In addition, the block diagrams used in the above description of the foregoing embodiment illustrate blocks of functional units. The functional blocks (constituent elements) are realized by any combination of hardware and/or software. In addition, means for realizing each functional block is not specifically limited. That is, each functional block may be realized by one apparatus in which the functional blocks are combined physically and/or logically or may be realized by two or more apparatuses that are physically and/or logically separated by connecting the plurality of apparatuses directly and/or indirectly (e.g., in a wired and/or wireless manner).

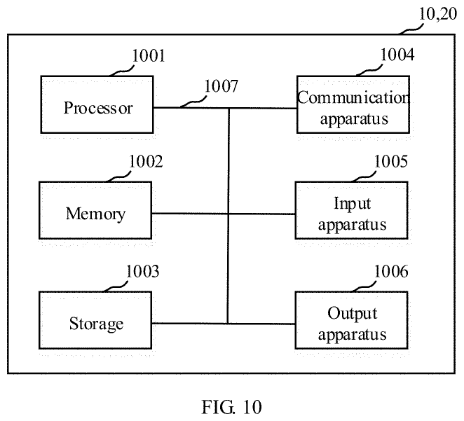

For example, the base station and the mobile station according to an embodiment of the present application may function as a computer that performs processes of a wireless communication method according to the present application. FIG. 10 is a block diagram illustrating an example of a hardware configuration of the base station and the mobile station according to an embodiment of the present application. The base station 10 and the user equipment 20 described above may be physically configured as a computer apparatus that includes a processor 1001, a memory 1002, a storage 1003, a communication apparatus 1004, an input apparatus 1005, an output apparatus 1006, and a bus 1007 or the like.

In addition, in the following description, a term “apparatus” can be replaced with a circuit, a device, a unit, or the like. The hardware configuration of the base station 10 and the user equipment 20 may be configured to include one apparatus or a plurality of apparatuses illustrated in the drawing or may be configured not to include some of the apparatuses.

For example, the processor 1001 only illustrates one, but may be a plurality of processors. In addition, the processing may be performed by one processor, or may be performed by one or more processors simultaneously, sequentially, or by other methods. Additionally, the processor 1001 can be installed by more than one chip.

The functions of the base station 10 and the user equipment 20 are realized by the following manners: reading predetermined software (program) on hardware such as the processor 1001 or the memory 1002 so that the processor 1001 can perform an arithmetic operation and by controlling communication by the communication apparatus 1004 and reading and/or writing of data in the memory 1002 and the storage 1003.

For example, the processor 1001 controls the entire computer by operating an operating system. The processor 1001 may be also configured as a central processing unit (CPU) that includes an interface with a peripheral apparatus, a control apparatus, an arithmetic apparatus, a register, and the like. For example, the receiving control unit 103 and the retransmission control unit 203 may be realized by the processor 1001.

In addition, the processor 1001 reads a program (program codes), a software module, data and so on from the storage 1003 and/or the communication apparatus 1004 to the memory 1002 and performs various processes according to the program, the software module, or the data. As the program, a program causing a computer to perform at least some of the operations described in the foregoing embodiment is used. For example, the retransmission control unit 203 of the user equipment 20 may be stored in the memory 1002 and realized by a control program that is operated by the processor 1001. Another functional block may be similarly realized. The memory 1002 is a computer-readable recording medium and may be configured by at least one of, for example, a read-only memory (ROM), an erasable programmable ROM (EPROM), an electrically erasable programmable ROM (EEPROM), and a random access memory (RAM), and other proper storage mediums. The memory 1002 may also be referred to as a register, a cache, a main memory (main storage apparatus), or the like. The memory 1002 can store a program (program codes), a software module, or the like which can be executed to perform an information transmission method and a wireless communication method according to an embodiment of the present application.

The storage 1002 is a computer-readable recording medium and may be configured by at least one of, for example, a flexible disk, a floppy (registered trademark) disk, a magneto-optical disk (e.g., a Compact Disc ROM (CD-ROM), etc.), a digital versatile disc, a Blu-ray (registered trademark) disc, a removable disk, a hard disk drive, a smart card, a flash memory (e.g., a card, a stick, or a key drive), a magnetic strip, a database, a server, and another appropriate medium. The storage 1003 may be also referred to as an auxiliary storage apparatus.

The communication apparatus 1004 is hardware (a transmission and reception device) that performs communication between computers via a wired and/or wireless network and is also referred to as, for example, a network device, a network controller, a network card, or a communication module. The communication apparatus 1004 may include a high frequency switch, a duplexer, a filter, a frequency synthesizer, etc., in order to implement, for example, Frequency Division Duplex (FDD) and/or Time Division Duplex (TDD). For example, the transmitting unit 101, the receiving unit 102, the receiving unit 201, and the transmitting unit 202 described above may be realized by the communication apparatus 1004.

The input apparatus 1005 is an input device (e.g., a keyboard, a mouse, a microphone, a switch, a button, or a sensor) that receives an input from the outside. The output apparatus 1006 is an output device (e.g., a display, a speaker, or an LED lamp) that performs an output to the outside. The input apparatus 1005 and the output apparatus 1006 may be configured to be integrated (e.g., a touch panel).

In addition, the apparatuses such as the processor 1001 and the memory 1002 are connected to the bus 1007 for communicating information. The bus 1007 may be configured as a single bus or may be configured by different buses between the apparatuses.

In addition, the base station 10 and the user equipment 20 may be configured to include hardware such as a microprocessor, a digital signal processor (DSP), an application specific integrated circuit (ASIC), a programmable logic device (PLD), a field programmable gate array (FPGA), or some or all of the functional blocks may be realized by the hardware. For example, the processor 1001 may be implemented in at least one of the hardware.

<Variants>

In addition, the terms described in this specification and/or terms necessary to understand this specification may be replaced with terms that have same or similar meanings. For example, a channel and/or a symbol may be a signal. In addition, a signal may be also a message. A reference signal may also be simply referred to as RS (Reference Signal), and may also be called pilot, pilot signal, etc. according to applicable standards. In addition, a component carrier (CC) may also be referred to as a cell, a frequency carrier, a carrier frequency, or the like.

In addition, the information, the parameter, or the like described in this specification may be represented by an absolute value, may be also represented by a relative value from a predetermined value, or may be also represented by another corresponding information. For example, a radio resource may be indicated using an index. Further, the formula or the like using these parameters may be different from those explicitly disclosed in this specification.

The names used for the above-described parameters are not limited in any respect. For example, various channels (Physical Uplink Control Channel (PUCCH), Physical Downlink Control Channel (PDCCH), or the like) and information elements can be identified with any appropriate names, thus various names allocated to the various channels and information elements are not limited in any respect.

The information, the signal, and the like described in this specification may be represented using any of various technologies. For example, the data, the order, the command, the information, the signal, the bit, the symbol, the chip, and the like mentioned throughout the foregoing description may be represented by a voltage, a current, an electromagnetic wave, a magnetic field, or a magnetic particle, an optical field or a photon, or any combination thereof.

In addition, information or the like can be output from a higher layer to a lower layer and/or from a lower layer to a higher layer). Information or the like may be input or output via a plurality of network nodes.

The input or output information, signal, or the like may be stored in a specific location (e.g., a memory) or may be managed with a management table. The input or output information, signal, or the like may be overwritten, updated, or edited. The output information, signal, or the like may be deleted. The input information, signal or the like may be transmitted to another apparatus.

The notification of information is not limited to the aspects/embodiments described in this specification and may be performed in accordance with other methods. For example, the notification of information may be performed with physical layer signaling (e.g., downlink control information (DCI), uplink control information (UCI)), higher layer signaling (e.g., radio resource control (RRC) signaling, broadcast information (master information block (MIB), a system information block (SIB) or the like), medium access control (MAC) signaling, or another signal, or a combination thereof.

Further, the physical layer signaling may be referred to as L1/L2 (Layer 1/Layer 2) control information (L1/L2 control signal), L1 control information (L1 control signal), and the like. In addition, The RRC signaling may be referred to as an RRC message or may be, for example, an RRC connection setup message or an RRC connection reconfiguration message. Furthermore, the MAC signaling can be notified, for example, by a MAC Control Unit (MAC CE).

In addition, notification of predetermined information (e.g., notification of “being X”) is not limited to being performed explicitly and may be performed implicitly (e.g., the notification of the predetermined information is not performed, the notification of other information is performed).

Determination may be made based on a value (0 or 1) represented by 1 bit, may be made based on a true or false value (boolean value) represented by true or false, or may be made based on comparison with a numerical value (e.g., comparison with a predetermined value).

Regardless of the fact that software is referred to as software, firmware, middleware, a microcode, or a hardware description language or is referred to as another name, the software is broadly interpreted to mean a command, a command set, a code, a code segment, a program code, a program, a sub-program, a software module, an application, a software application, a software package, a routine, a subroutine, an object, an executable file, an execution thread, a procedure, a function, or the like.

In addition, software, a command, information, or the like may be transmitted or received via a transmission medium. For example, when software is transmitted from a website, a server, or another remote source using a wired technology such as a coaxial cable, an optical cable, a twisted pair, and a digital subscriber line (DSL) and/or a wireless technology such as an infrared ray, radio, and microwaves, the wired technology and/or the wireless technology is included in the definition of a transmission medium.

The terms “system” and “network” used in this specification are interchangeably used.

In this specification, the terms “base station”, “wireless station”, “eNB”, “gNB” “cell”, “sector” “cell group”, “carrier”, and “component carrier” can be interchangeably used in this specification. A base station can be also referred to as the term such as a fixed station, a NodeB, an eNodeB (eNB), an access point, a transmission point, a reception point, a femtocell, or a small cell.

A base station can accommodate one or more (e.g., three) cells (also referred to as “sectors”). When a base station accommodates a plurality of cells, the entire coverage area of the base station can be divided into a plurality of smaller areas and a communication service can be also provided in each of the smaller areas using a base station subsystem (e.g., an indoor small-sized base station remote radio head (RRH)). The term “cell” or “sector” refers to a part or all of a coverage area of a base station and/or a base station subsystem that provides a communication service in the coverage area.

In this specification, terms such as “mobile station (MS)”, “user terminal”, “user equipment (UE)”, and “terminal” are used interchangeably. The base station is sometimes referred to by a fixed station, a NodeB, an eNodeB (eNB), an access point, a transmission point, a reception point, a femto cell, a small cell, and the like.

A mobile station is referred to as a subscriber station, a mobile unit, a subscriber unit, a radio unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or several other appropriate terms by those skilled in the art.

In addition, the wireless base station in this specification can also be replaced with a user terminal. For example, each mode/embodiment of the present application can be applied to a configuration in which communication between a radio base station and a user terminal is replaced with communication between a plurality of user-to-device (D2D) devices. At this time, the function of the above-described wireless base station 10 can be regarded as a function of the user terminal 20. In addition, words such as “uplink” and “downlink” can also be replaced with “side”. For example, the uplink channel can also be replaced with a side channel.

Similarly, the user terminal in this specification can also be replaced with a wireless base station. At this time, the function of the user terminal 20 described above can be regarded as a function of the wireless base station 10.

In this specification, a specific operation performed by the base station may be also performed by an upper node. In a network formed by one or more network nodes including a base station, it should be apparent that various operations performed for inter-terminal communicate may be performed by a base station, one or more network nodes (e.g., a Mobility Management Entity (MME), a Serving-Gateway (S-GW) may be considered, but the present application is not limited thereto) other than the base station, or a combination thereof.

The aspects/embodiments described in this specification may be individually used, may be combined, or may be switched during execution. In addition, the order of the process procedure, the sequence, the flowchart, or the like of each aspect/embodiment described in this specification may be interchanged unless there is contradiction. For example, in the method described in this specification, various steps have been proposed in exemplary orders and the present application is not limited to the proposed specific orders.

Each aspect/embodiment described in this specification may be applied to a system in which Long Term Evolution (LTE), LTE-Advanced (LTE-A), LTE-Beyond (LTE-B), Super 3rd Generation Mobile Communication System (SUPER 3G), Advanced International Mobile Telecommunications (IMT-Advanced), 4th generation mobile communication system (4G), 5th generation mobile communication system (5G), Future Radio Access (FRA), New-RAT (Radio Access Technology), New Radio (NR), New Radio Access (NX), Future generation radio Access (FX), Global System for Mobile Communications (GSM (registered trademark)), Code Division Multiple Access 2000 (CDMA2000), Ultra Mobile Broadband (UMB), IEEE 802.11 (Wi-Fi (Registered trademark)), IEEE 802.16 (WiMAX (registered trademark)), IEEE 802.20, Ultra-WideBand (UWB), Bluetooth (registered trademark) and other appropriate systems are used and/or a next generation system extended based on the system.

The description “based on” used in this specification does not imply “based only on” unless otherwise specified. In other words, the description of “based on” implies both of “based only on” and “based at least on.”

When reference is made to elements in which names “first,” “second,” and the like are used in this specification, the number or the order of the elements is not generally limited. The names can be used in this specification as a method to conveniently distinguish two or more elements from each other. Accordingly, reference to first and second elements does not imply that only two elements are employed or the first element is prior to the second element in some ways.

The term “determining” used in this specification may include a wide variety of operations. Regarding the “determining,” for example, calculating, computing, processing, deriving, investigating, looking up (e.g., looking up in a table, a database, or another data structure), and ascertaining may be considered as “determining.” In addition, regarding the “determining,” for example, receiving (e.g., receiving information), transmitting (e.g., transmitting information), inputting, outputting, and accessing (e.g., accessing data in a memory) may be considered as “determining”. In addition, regarding the “determining,” for example, resolving, selecting, choosing, establishing, and comparing may be considered as “determining”. That is, the “determining” can include a case in which any operation is “determined.”

The term “connected” or “coupled” or any modification of the term means various types of direct or indirect connection or coupling between two or more elements and can include the presence of one or more intermediate elements between two mutually “connected” or “coupled” elements. The connection or the coupling between elements may be physical connection, logical connection, or any combination thereof. For example, “connection” can also be replaced with “access to”. When the connection or the coupling is used in this specification, two elements can be considered to be mutually “connected” or “coupled” by using one or more electric wires, cables, and/or printed electric connection and using electromagnetic energy such as electromagnetic energy with a wavelength of a radio frequency region, a microwave region, and a light (both visible light and invisible light) region as several non-limited and non-inclusive examples.

The terms “including” and “comprising” are intended to be inclusive as in the term “comprise” as long as “including,” “comprising,” and modifications thereof are used in this specification or the claims. Further, the term “or” used in this specification or the claims is intended not to be exclusive OR.

The present application has been described above in detail, but it is obvious to those skilled in the art that the present application is not limited to the embodiments described in the specification. The present application can be implemented as a modification and modification without departing from the spirit and scope of the present application as defined by the appended claims. Accordingly, the description of the specification is intended to be illustrative, and is not intended to limit the present application.

1. A wireless communication method, the method comprising:
jointly selecting multiplexing identification information and a reference signal for a user equipment, wherein the multiplexing identification information is used to distinguish data of the user equipment from data of other user equipment;
processing the data by using the selected multiplexing identification information;
transmitting the processed data and the reference signal.

2. The method of claim 1, wherein said jointly selecting multiplexing identification information and a reference signal for the user equipment comprises:
selecting the multiplexing identification information and the reference signal respectively from a multiplexing identification information set and a reference signal set based on same parameter.

3. The method of claim 1, wherein said jointly selecting multiplexing identification information and a reference signal for the user equipment comprises:
selecting one of the multiplexing identification information and the reference signal from a multiplexing identification information set or a reference signal set; and
selecting, according to one of the multiplexing identification information and the reference signal that is selected, based on a predetermined association rule between the multiplexing identification information and the reference signal, the other one of the multiplexing identification information and the reference signal from the multiplexing identification information set or the reference signal set.

4. The method of claim 2, wherein
receiving, through high layer signaling, the multiplexing identification information set and the reference signal set configured by a base station.

5. The method of claim 1, wherein said jointly selecting multiplexing identification information and a reference signal for the user equipment comprises:
selecting a pair of multiplexing identification information and reference signal from a plurality of pairs of multiplexing identification information and reference signal.

6. The method of claim 5, wherein
receiving, through high layer signaling, the plurality of pairs of multiplexing identification information and reference signal configured by a base station.

7. The method of claim 1, further comprising:
receiving the data and the reference signal transmitted from the user equipment by a base station;
jointly selecting the multiplexing identification information and the reference signal for the user equipment by the base station, wherein the multiplexing identification information is used to distinguish data of the user equipment from data of other user equipment;
demodulating the data according to the multiplexing identification information and the reference signal that are selected by the base station.

8. The method of claim 7, wherein said jointly selecting multiplexing identification information and the reference signal for the user equipment comprises:
selecting the multiplexing identification information and the reference signal respectively from a multiplexing identification information set and a reference signal set based on the same parameter.

9. The method of claim 7, wherein said jointly selecting multiplexing identification information and the reference signal for the user equipment comprises:
selecting one of the multiplexing identification information and the reference signal from a multiplexing identification information set or a reference signal set; and
selecting, according to one of the multiplexing identification information and the reference signal that is selected, based on a predetermined association rule between the multiplexing identification information and the reference signal, the other one of the multiplexing identification information and the reference signal from the multiplexing identification information set or the reference signal set.

10. The method of claim 8, wherein
transmitting, through high layer signaling, the multiplexing identification information set and the reference signal set to the user equipment by the base station.

11. The method of claim 7, wherein said jointly selecting multiplexing identification information and the reference signal for the user equipment comprises:
selecting a pair of multiplexing identification information and reference signal from a plurality of pairs of multiplexing identification information and reference signal.

12. The method of claim 11 wherein
transmitting, through high layer signaling, the plurality of pairs of multiplexing identification information and reference signal to the user equipment by the base station.

13. A user equipment, comprising:
a selecting unit configured to jointly select multiplexing identification information and a reference signal for the user equipment, the multiplexing identification information being used to distinguish data of the user equipment from data of other user equipment;
a processing unit configured to process the data by using the selected multiplexing identification information;
a transmitting unit configured to transmit the processed data and the reference signal.

14. The user equipment of claim 13, wherein
the selecting unit selects the multiplexing identification information and the reference signal respectively from a multiplexing identification information set and a reference signal set based on the same parameter.

15. The user equipment of claim 13, wherein
the selecting unit correspondingly selects one of the multiplexing identification information and the reference signal from a multiplexing identification information set or a reference signal set;
the selecting unit selects, according to one of the multiplexing identification information and the reference signal that is selected, based on a predetermined association rule between the multiplexing identification information and the reference signal, the other one of the multiplexing identification information and the reference signal from the multiplexing identification information set or the reference signal set.

16. The user equipment of claim 13, wherein
the selecting unit selects a pair of multiplexing identification information and reference signal from a plurality of pairs of multiplexing identification information and reference signal.

17. A base station, comprising:
a receiving unit configured to receive data and a reference signal transmitted from a user equipment;
a selecting unit configured to jointly select multiplexing identification information and a reference signal for the user equipment, the multiplexing identification information being used to distinguish data of the user equipment from data of other user equipment;
a demodulating unit configured to demodulate the data according to the multiplexing identification information and the reference signal that are selected.

18. The base station according to claim 17, wherein said jointly selecting multiplexing identification information and a reference signal for the user equipment comprises:
the selecting unit selects the multiplexing identification information and the reference signal respectively from a multiplexing identification information set and a reference signal set based on the same parameter.

19. The base station according to claim 17, wherein said jointly selecting multiplexing identification information and a reference signal for the user equipment comprises:
the selecting unit correspondingly selects one of the multiplexing identification information and the reference signal from a multiplexing identification information set or a reference signal set;
the selecting unit selects, according to one of the multiplexing identification information and the reference signal that is selected, based on a predetermined association rule between the multiplexing identification information and the reference signal, the other one of the multiplexing identification information and the reference signal from the multiplexing identification information set or the reference signal set.

20. The base station according to claim 17, wherein said jointly selecting multiplexing identification information and a reference signal for the user equipment comprises:
the selection unit selects a pair of multiplexing identification information and reference signal from a plurality of pairs of multiplexing identification information and reference signal.
